(19) United States
(12) Patent Application Publication
(10) Pub. No.: US 2024/0241325 A1
(43) Pub. Date: Jul. 18, 2024

(54) RECEPTACLE FOR OPTICAL CONNECTOR

(71) Applicant: Mei-Miao LIU, Taipei City (TW)

(72) Inventor: Mei-Miao LIU, Taipei City (TW)

(21) Appl. No.: 18/399,707

(22) Filed: Dec. 29, 2023

(30) Foreign Application Priority Data
Jan. 13, 2023 (TW) 112101457

(51) Int. Cl. G02B 6/38

(52) U.S. Cl. CPC G02B 6/3893; G02B 6/387

(57) ABSTRACT

The present invention provides a receptacle inserted by an optical connector comprising a receptacle body, actuating structure, and a flexible covering structure. The receptacle body comprises a slot and a coupling part having coupling through holes for connecting with the optical connector. The actuating structure is slidably arranged into the slot. When the optical connector is inserted into the slot, the actuating structure is pushed to move to a first position, and when the optical connector is pulled out along the slot, the actuating structure is pushed to move to the second position. The flexible covering structure is connected to the actuating structure, wherein when the actuating structure is moved to the first position, the flexible covering structure is flexibly deformed to reveal the coupling through holes; when the actuating structure is moved to the second position, the coupling through hole is covered by the flexible covering structure.

### CROSS-REFERENCE TO RELATED APPLICATION

This application claims the benefit of Taiwan Patent Application No. 112101457, filed on Jan. 13, 2023, in the Taiwan Intellectual Property Office of the R.O.C, the disclosure of which is incorporated herein in its entirety by reference.

### FIELD OF INVENTION

The present invention relates to a receptacle for an optical connector. In particular, it relates to a receptacle that utilizes a protective cover to couple with the optical connector by revealing a coupling through hole when the optical connector is inserted, and to cover the coupling through hole when the optical connector is pulled out.

### BACKGROUND OF THE INVENTION

Due to the advantages of high frequency bandwidth and low loss, optical fibers have been widely used as signal transmission media in recent years. The use of optical fiber has already had a major revolutionary impact in the communications industry. Nowadays, 100G optical module communication is not enough, and the future will be expected to move towards the era of 400G optical module communications.

In order to achieve the goal, the optical connector with optical fiber transmission medium has become the main force for the data center to increase the amount of data and the growth of the transmission rate. However, in some usage scenarios, such as transmission towers or relay stations, in addition to using optical fibers to transmit information, wires for transmitting power are also required to supply power to receivers and transmitters. Based on this demand, there are optical connector products on the market that can transmit optical signals and power at the same time.

The above information disclosed in this section is only for enhancement of understanding of the background of the described technology and therefore it may contain information that does not form the prior art that is already known to a person of ordinary skill in the art.

### SUMMARY OF THE INVENTION

The present invention provides a receptacle, which has a protective design to protect the coupling part coupled with the optical connector from contamination. When the optical connector is inserted, the flexible covering structure is driven out of the covering position, so that the optical connector can be smoothly coupled to the receptacle, and when the optical connector is pulled out, the flexible covering structure is restored to its original position to protect the receptacle from dust contamination.

The present invention provides a receptacle, comprising: a receptacle body, having a slot, the slot having a coupling part, the coupling part having a coupling through hole, which is coupled with the optical connector inserted through the slot; a driving structure, slidably disposed into the slot, wherein when the optical connector is inserted into the slot, the driving structure is pushed by the optical connector to move to a first position, and when the optical connector is moved by a pulling force, the driving structure is pushed by the optical connector to move to a second position; and a flexible covering structure, connected to the driving structure, wherein when the driving structure is in the first position, the flexible covering structure bends to reveal the coupling through hole, and when the driving structure moves to the second position, the flexible covering structure blocks the coupling through hole.

In one embodiment of the present invention, the receptacle body has a first limiting structure and a second limiting structure, the first limiting structure is disposed on an inner wall of the slot and is located on a side of the coupling part, and the second limiting structure is disposed on the inner wall adjacent to an insertion opening of the slot. The driving structure has a sliding base and a cantilever, the sliding base is slidably located at a bottom of the slot, one end of the cantilever is connected to a side of the sliding base, and the other end of the cantilever extends toward the insertion opening of the slot. The cantilever has a first actuating structure, a second actuating structure and a third limiting structure, the first actuating structure is disposed at a free end of the cantilever, the second actuating structure is disposed on the cantilever closed to the sliding base, and the third limiting structure is disposed on both sides of the first actuating structure.

In one embodiment of the present invention, the receptacle body has a first limiting structure and a second limiting structure, the first limiting structure is disposed on the inner wall of the slot and is located on a side of the coupling part, the second limiting structure is disposed on an insertion opening of the slot and extends toward the coupling part, and a bottom surface of the second limiting structure has a guiding slope. The cantilever has a first actuating structure, a second actuating structure and a fourth limiting structure, wherein the first actuating structure is disposed at a free end of the cantilever, and the second actuating structure is disposed on the cantilever closed to the sliding base, and the fourth limiting structure is disposed on a bottom of the first actuating structure.

The present invention will become better understood with reference to the following detailed description considered in connection with the accompanying drawings.

### BRIEF DESCRIPTION OF THE DRAWINGS

The detailed structure, operating principle and effects of the present invention will now be described in more details hereinafter with reference to the accompanying drawings that show various embodiments of the present invention as follows.

FIG. 1A is a three-dimensional schematic diagram of the optical connector in the present invention.

FIG. 1B is a schematic three-dimensional cross-sectional diagram of the optical connector on the XY plane in the present invention.

FIG. 2A is a schematic diagram of the combination of the flexible covering structure and the actuating structure.

FIG. 2B is a schematic diagram of the combination of the actuating structure and the flexible covering structure.

FIGS. 3A to 3D are operational schematic diagrams of an embodiment of uncovering the coupling part in the present invention.

FIGS. 3E to 3I are operational schematic diagrams of an embodiment of the flexible covering structure covering the coupling part when the optical connector is pulled out from the receptacle in the present invention.

FIG. 4A is a schematic diagram of an embodiment of the actuating structure in the present invention.

FIG. 4B is partial cross-sectional schematic diagram of another embodiment of the receptacle in the present invention.

FIG. 5A is a schematic diagram of an embodiment of inserting an optical connector into a receptacle.

FIGS. 5B to 5D are operational schematic diagrams of another embodiment of the flexible covering structure covering the coupling part when the optical connector is pulled out from the receptacle in the present invention.

FIG. 6 is a schematic diagram of another embodiment of the receptacle body in the present invention.

### DETAILED DESCRIPTION OF THE PREFERRED EMBODIMENTS

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this invention will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way.

For convenience, certain terms employed in the specification, examples and appended claims are collected here. Unless defined otherwise, all technical and scientific terms used herein have the same meaning as commonly understood by one of the ordinary skill in the art to which this invention belongs.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The singular forms “a”, “and”, and “the” are used herein to include plural referents unless the context clearly dictates otherwise.

The following descriptions are provided to elucidate a receptacle for an optical connector and to aid it of skilled in the art in practicing this invention. These embodiments are merely exemplary embodiments and in no way to be considered to limit the scope of the invention in any manner.

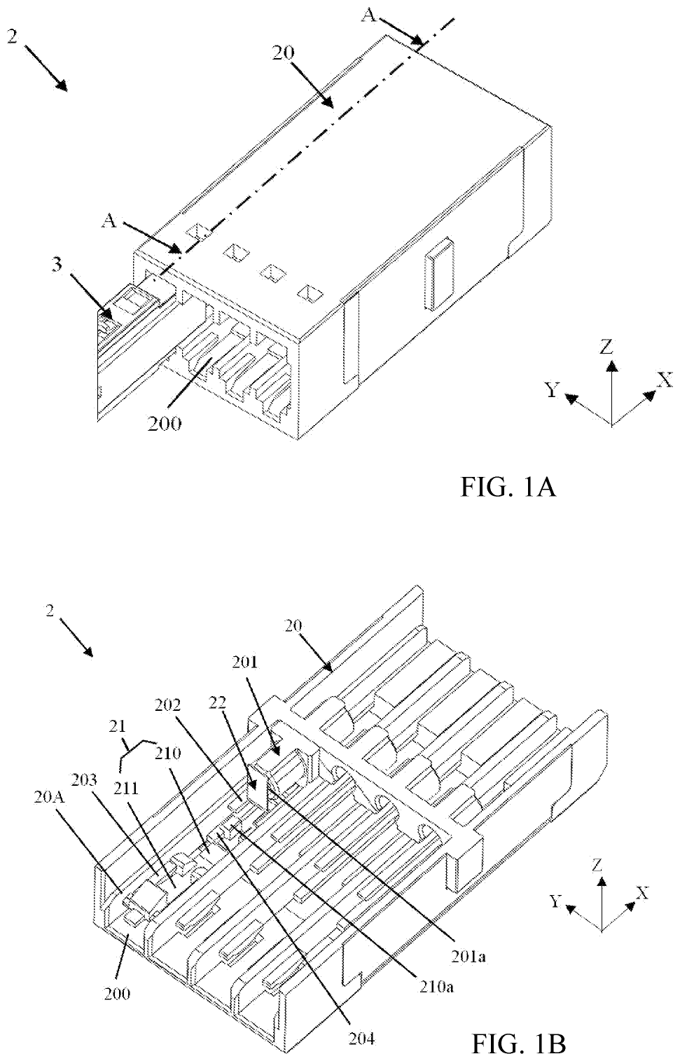

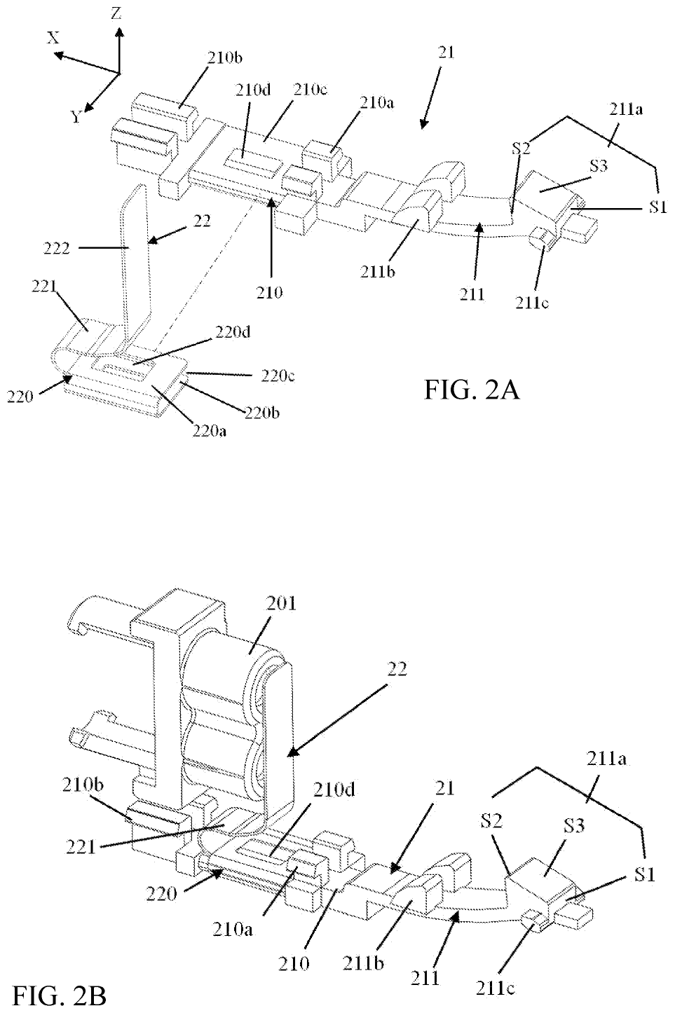

Please refer to FIGS. 1A and 1B, FIG. 1A is a three-dimensional schematic diagram of the optical connector, and FIG. 1B is a schematic three-dimensional cross-sectional diagram of the optical connector on the XY plane. The receptacle 2 shown in this embodiment is assembled with the optical connector 3. The receptacle 2 includes a receptacle body 20, a driving structure 21 and a flexible covering structure 22. The receptacle body 20 has a slot 200, and a coupling part 201 is disposed into the slot 200. The coupling part 201 has a coupling through hole 201a, that is connected with the optical connector 3 inserted via the slot 200. The receptacle body 20 further includes a first limiting structure 202 and a second limiting structure 203. In this embodiment, the first limiting structure 202 and the second limiting structure 203 are respectively disposed on the inner wall 20A of the slot 200. The first limiting structure 202 is located on one side of the coupling part 201, and the second limiting structure 203 is disposed on the inner wall 20A closed to the opening of the slot 200. In one embodiment, the first limiting structure 202 and second limiting structure 203 are protruded from the inner wall 20A toward the slot 200 with a predetermined width.

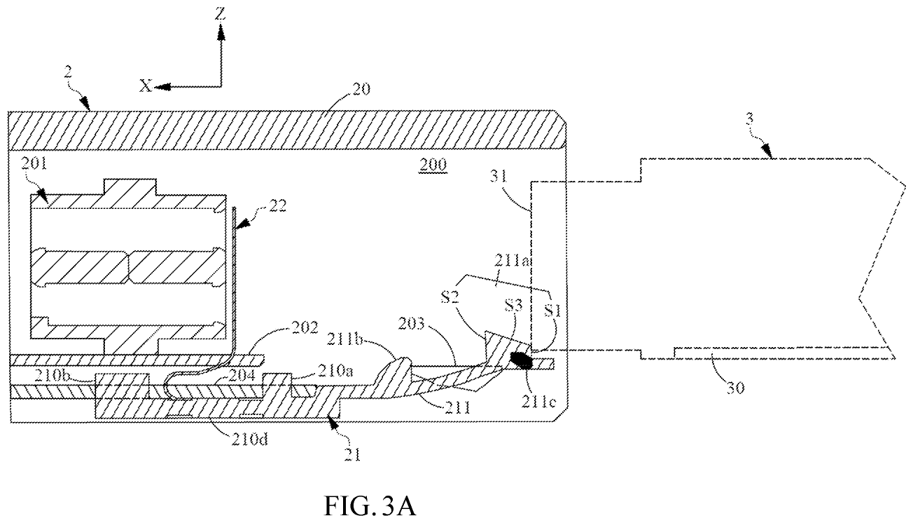

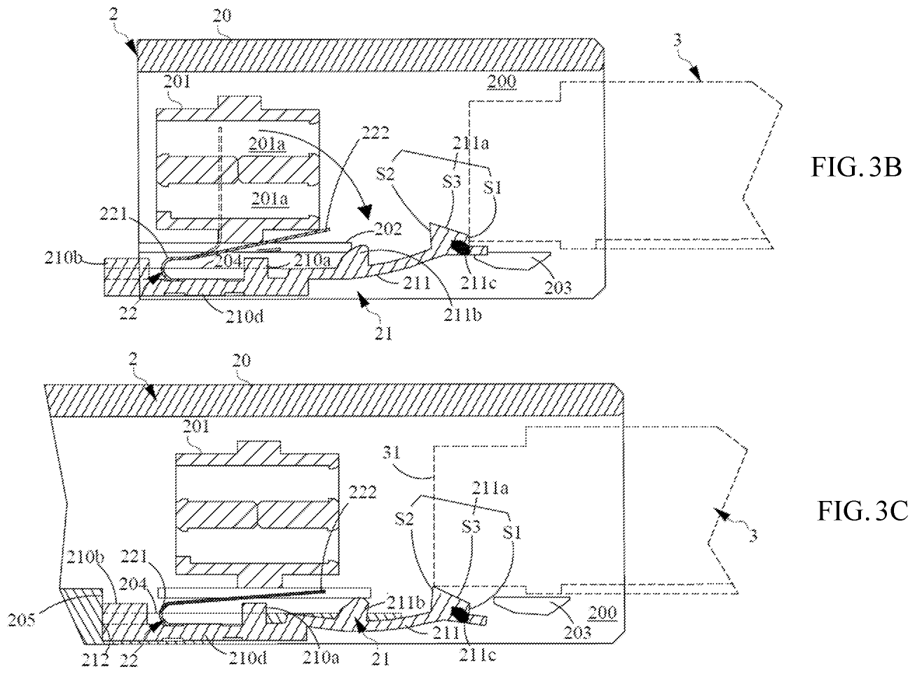

The driving structure 21 is slidably disposed in the slot 200. When the optical connector 3 is inserted into the slot 200, the driving structure 21 is pushed by the optical connector 3 and moves toward the coupling part 201 (the positive X-axis direction in this embodiment). On the contrary, when the optical connector 3 is pulled out, the driving structure 21 is pushed by the optical connector 3 and moves along the pull-out direction of the optical connector 3 (the negative X-axis direction in this embodiment). The detailed operation would be described later. As shown in FIGS. 2A and 2B, FIG. 2A is a schematic diagram of the combination of the flexible covering structure and the actuating structure, and FIG. 2B is a schematic diagram of the combination of the actuating structure and the flexible covering structure. The driving structure 21 further includes a sliding base 210 and a cantilever 211. The sliding base 210 is slidably installed at the bottom of the slot 200.

In one embodiment, the sliding base 210 is slidably disposed between the coupling part 201 and the bottom of the slot 200. Please refer to FIG. 2A and FIG. 1B. The sliding base 210 includes a base body 210c, which has a plurality of first guiding structures 210a and 210b. The first guiding structure 210a is disposed on a side of the base body 210c closed to the opening of the slot 200, and the first guiding structure 210b is disposed on a side of the base body 210c closed to the coupling part 201. The inner walls 20A on both sides of the bottom of the receptacle body 20 have a second guiding structure 204 corresponding to the first guiding structures 210a and 210b, and the second guiding structure 204 is slidably contact with the first guiding structures 210a and 210b. In this embodiment, the first guiding structures 210a and 210b are inverted L-shaped structures and are slidably connected to the second guiding structure 204.

As shown in FIGS. 2A and 2B, one end of the cantilever 211 is connected to one side of the sliding base 210, and the other end of the cantilever 211 is a free end that extends toward the insertion opening of the slot 200. In one embodiment, the cantilever 211 further has a first actuating structure 211a, a second actuating structure 211b and a third limiting structure 211c, wherein the first actuating structure 211a is disposed at the free end of the cantilever 211, the first actuating structure 211a is disposed on the free end of the cantilever 211, the second actuating structure 211b is disposed on the cantilever 211 closed to the sliding base 210, and the third limiting structure 211c is disposed on both sides of the first actuating structure 211a. In one embodiment, the first actuating structure 211a further has a first leaning surface S1, a second leaning surface S2, and an inclined surface S3 respectively connecting to the first leaning surface S1 and the second leaning surface S2. The function would be described later.

The flexible covering structure 22 is connected to the driving structure 21. In this embodiment, the flexible covering structure 22 has a fixing base 220, a flexible connecting part 221 and a covering piece 222. The fixing base 220 includes a top plate 220a and a bottom plate 220b connected to the top plate 220a. The top plate 220a and the bottom plate 220b respectively have fixing through holes 220d. One side of the fixing base 220 has a clamping opening 220c. The sliding base 210 of the driving structure 21 is installed into the fixing base 220 through the clamping opening 220c. In order to enhance the fixing effect, a positioning structure 210d is disposed on the upper and lower surfaces of the base body 210c of the sliding base 210. When the sliding base 210 is installed on the fixing base 220 via the clamp opening 220c, the positioning structure 210d penetrates into the corresponding fixing through hole 220d, resulting in a tight fit, ensuring that the flexible covering structure 22 can be firmly fixed on the driving structure 21. The flexible connection part 221 is connected to the fixing base 220, and one end of the covering piece 222 is connected to the flexible connecting part 221. In this embodiment, the covering piece 222 of the flexible covering structure 22 stands upright to cover the coupling through hole 201a of the coupling part 201 in a first state. In a second state, the covering piece 222 is pushed by the coupling part 201 and rotates clockwise to reveal the coupling through hole 201a, so that the signal terminal of the optical connector 3 can be inserted into the coupling through hole 201a. The detailed operation would be described later.

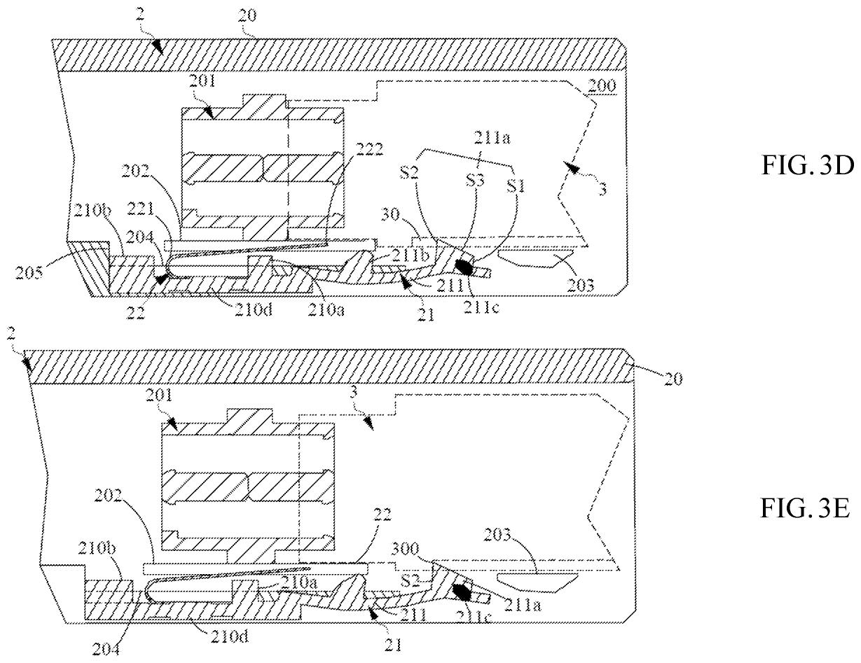

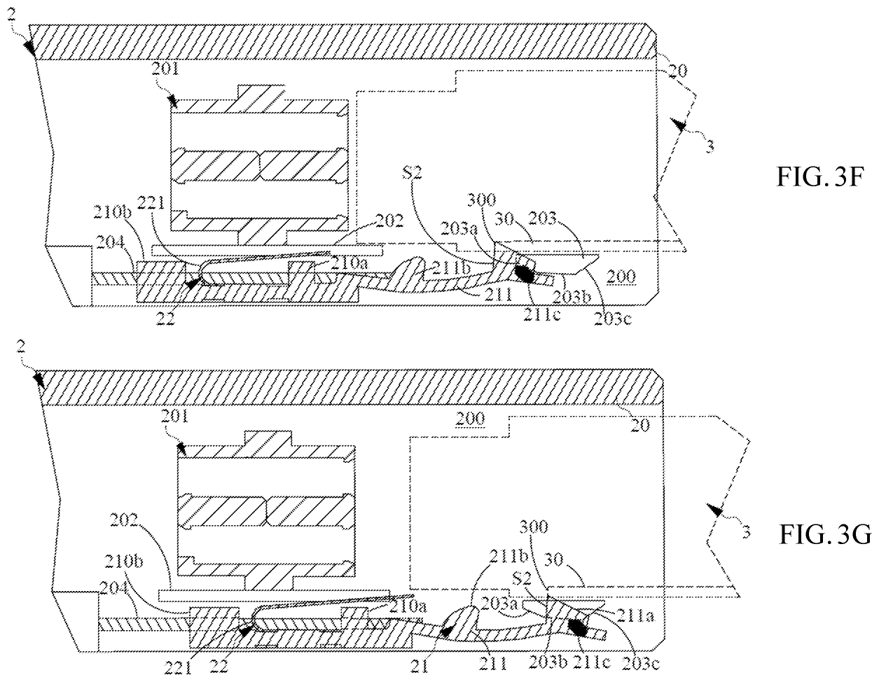

Next, the operation method of the covering coupling part would be described. Please refer to FIGS. 3A to 3D, which are operational schematic diagrams of an embodiment of uncovering the coupling part in the present invention. FIGS. 3A to 3D are schematic diagrams of the AA cross-section shown in FIG. 1A. When the optical connector 3 is inserted into the slot 200 of the receptacle 2, as shown in FIG. 3A, the front end surface 31 of the optical connector 3 is leaned against the first leaning surface S1 of the first actuating structure 211a and pushes the driving structure 21 to move toward the coupling part 201 along the X-axis. When the optical connector 3 continues to be pushed inward, since the flexible covering structure 22 is connected to the driving structure 21, the flexible covering structure 22 would also move toward the coupling part 201. As shown in FIG. 3B, when the driving structure 21 is pushed by the optical connector 3, causing the flexible covering structure 22 to move and contact the coupling part 201, the covering piece 222 of the flexible covering structure 22 is pressed by the coupling part 201, so that the covering piece 222 rotates clockwise. In the meantime, since the covering piece 222 rotates clockwise, the flexible connecting part 221 flexibly bends and accumulates the elastic restoring force. When the covering piece 222 rotates clockwise, the coupling hole 201a of the coupling part 201 would be revealed.

As shown in FIG. 3B, when the driving structure 21 continues to be pushed by the optical connector 3, the second actuating structure 211b on the driving structure 21 is leaned against the edge of the first limiting structure 202. During the process of moving optical connector 3, the cantilever 211 is driven to rotate clockwise and bend due to the force of the first limiting structure 202, resulting in a state as shown in FIG. 3C. In FIG. 3C, when the driving structure 21 moves to the first position, the end surface 212 of the driving structure 21 is leaned against the stopping structure 205 disposed into the receptacle 2, and the first leaning surface S1 is separated from the optical connector 3. At this time, since the driving structure 21 is blocked by the stopping structure 205, it does not move. Therefore, when the optical connector 3 continues to move toward the coupling part 201, the end surface 31 of the optical connector 3 pushes the inclined surface S3 and continues to press the cantilever 211 clockwise, so that the cantilever 211 accumulates elastic restoring force. In the meantime, the optical connector 3 continues to move toward the coupling part 201, and eventually, as shown in FIG. 3D, the optical connector 3 is plugged into the coupling part 201. It should be noted that since the cantilever 211 is flexible, although the optical connector 3 presses the inclined surface S3 to cause the cantilever 211 to bend flexibly, the inclined surface S3 is no longer pressed by the optical connector 3 when the optical connector 3 is inserted into the coupling part 201. Therefore, the cantilever 21 rebounds counterclockwise, causing the first actuating structure 211a to spring into the groove 30 at the bottom of the optical connector 3.

Next, pulling out the optical connector and automatically covering the coupling part by the flexible covering structure are described. FIGS. 3E to 3I are operational schematic diagrams of one embodiment of covering coupling part in the receptacle. As shown in FIG. 3E, the user would like to pull out the optical connector 3 from the receptacle 2. During the pull-out process, the inner wall 300 of the groove 30 of the optical connector 3 is leaned against the first actuating structure 211a of the second leaning surface S2. Therefore, when the optical connector 3 is pulled out, the inner wall 300 of the groove 30 would push the driving structure 21 outwardly, thereby driving the driving structure 21 to move outwardly. As shown in FIGS. 1B, 2A and 3F, the third limiting structure 211c on the driving structure 21 protrudes in the positive and negative Y-axis directions, and the second limiting structure 203 is disposed on the inner wall and extends toward the positive and negative Y-axis directions. Therefore, when the optical connector 3 continues to be pulled outwardly, the third limiting structure 211c is leaned against the second limiting structure 203, causing the third limiting structure 211c to be pressed downward (moving in the negative Z-axis direction). In this embodiment, the second limiting structure 203 has a first guiding surface 203a, a second guiding surface 203b and a third guiding surface 203c, wherein the third limiting structure 211c contacts the first guiding surface 203a firstly. In this embodiment, the first guiding surface 203a is an inclined surface, when the optical connector 3 continues to be pulled outwardly, the third limiting structure 211c moves downward along the first guiding surface 203a, and is further pressed by the first guiding surface 203a, thereby driving the cantilever 211 to bend clockwise.

The third limiting structure 211c continues to be pushed by the inner wall 300, and the third limiting structure 211c continues downwardly and is guided by the second guiding surface 203b. The second guiding surface 203b can be a flat surface or an inclined surface. As the third limiting structure 211c continues to move downwardly, the cantilever 211 accumulates flexible force, and on the other hand, it also drives the first actuating structure 211a to move downwardly, causing the second leaning surface S2 to separate from the inner wall 300, resulting in a state shown in FIG. 3G. As shown in FIG. 3H, after the third limiting structure 211c is separated from the second guiding surface 203b, the elastic force accumulated by the cantilever 211 is released to lift the first actuating structure 211a upwardly. Since the third guiding surface 203c no longer restrains the first actuating structure 211a, the first actuating structure gradually rises. In the meantime, since the optical connector 3 is no longer interfered by the first actuating structure 211a, it can be pulled out, and finally separated from the receptacle 2. After the optical connector 3 is pulled out, the first actuating structure 211a also returns to the initial position, as shown in FIG. 3I.

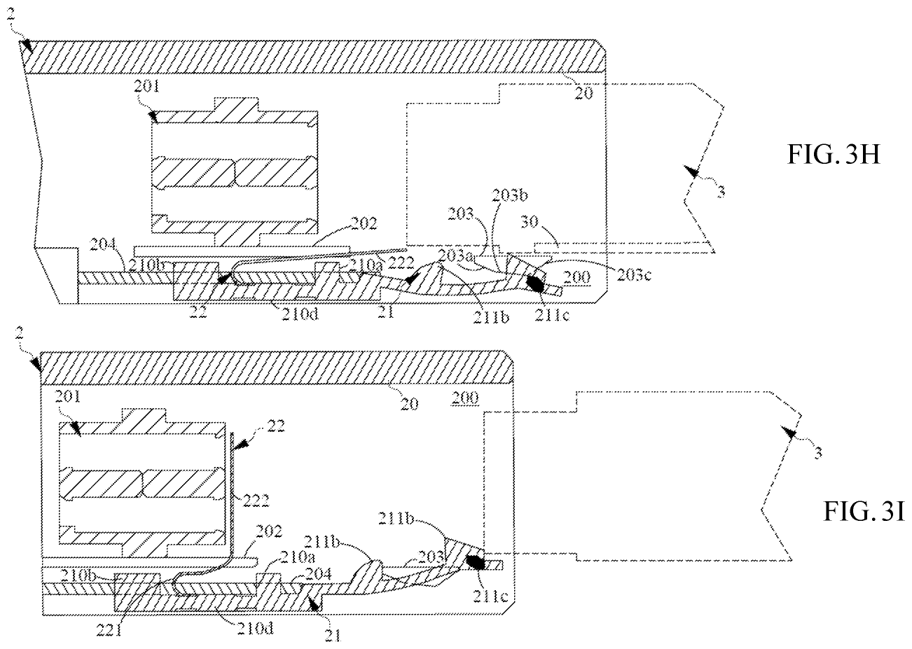

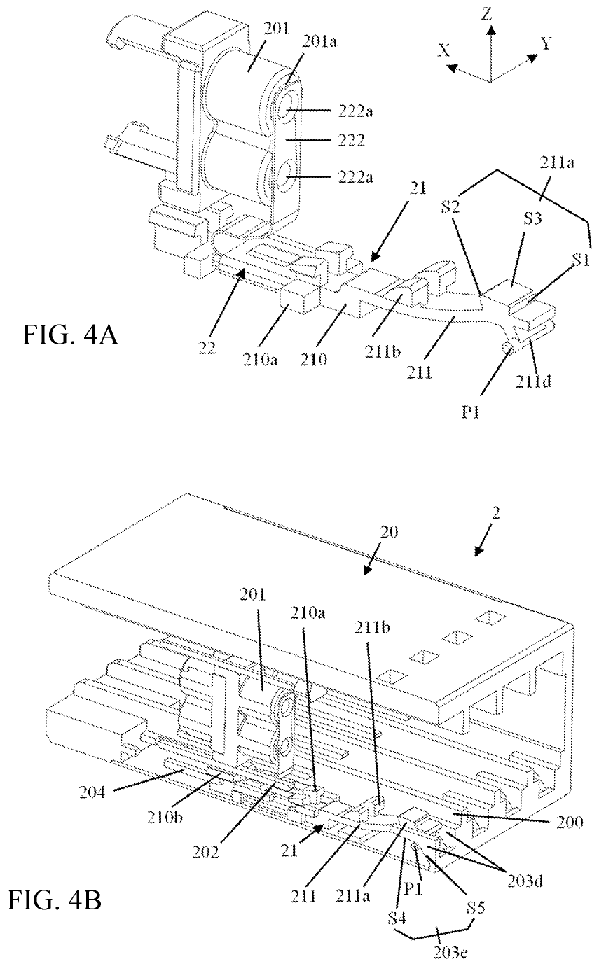

Please refer to FIGS. 4A and 4B, FIG. 4A is a schematic diagram of an embodiment of the actuating structure, and FIG. 4B is a partial cross-sectional schematic diagram of another embodiment of the receptacle. In this embodiment, the driving structure is similar to that in FIG. 2B. The only difference is that in the driving structure of this embodiment, there is a fourth limiting structure 211d extending obliquely below the first actuating structure 211a at the end of the cantilever 211. In this embodiment, the stopping column P1 is formed by the fourth limiting structure 211d protruding toward the Y-axis. In the receptacle 2, it is similar to the embodiment of FIG. 2A. The only difference is that the second limiting structure 203d in this embodiment has a guiding slope 203e, which includes a first guiding slope S4 and a second guiding surface S5, those functions would be described later.

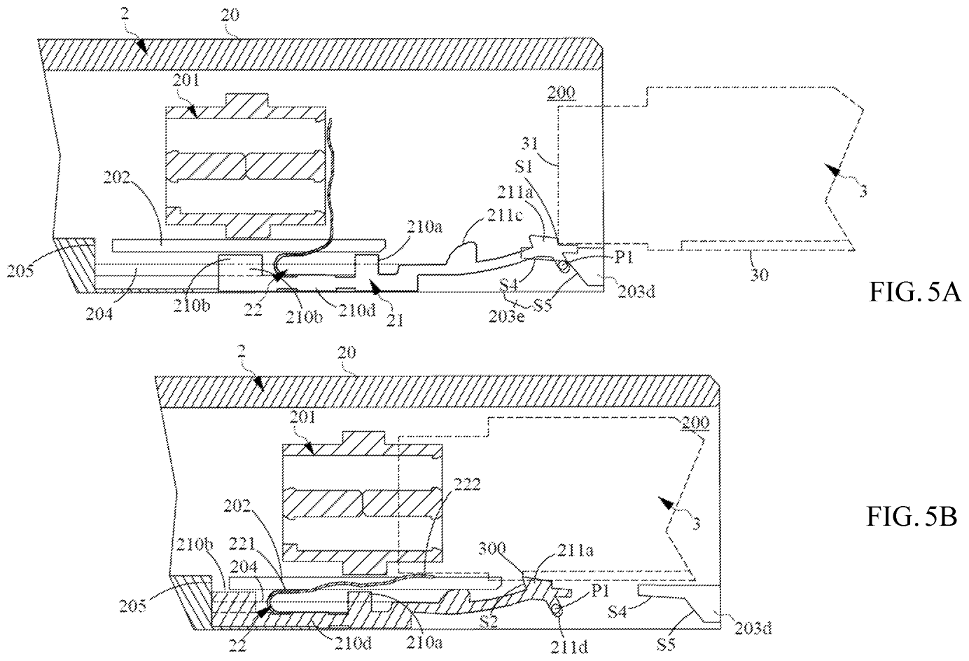

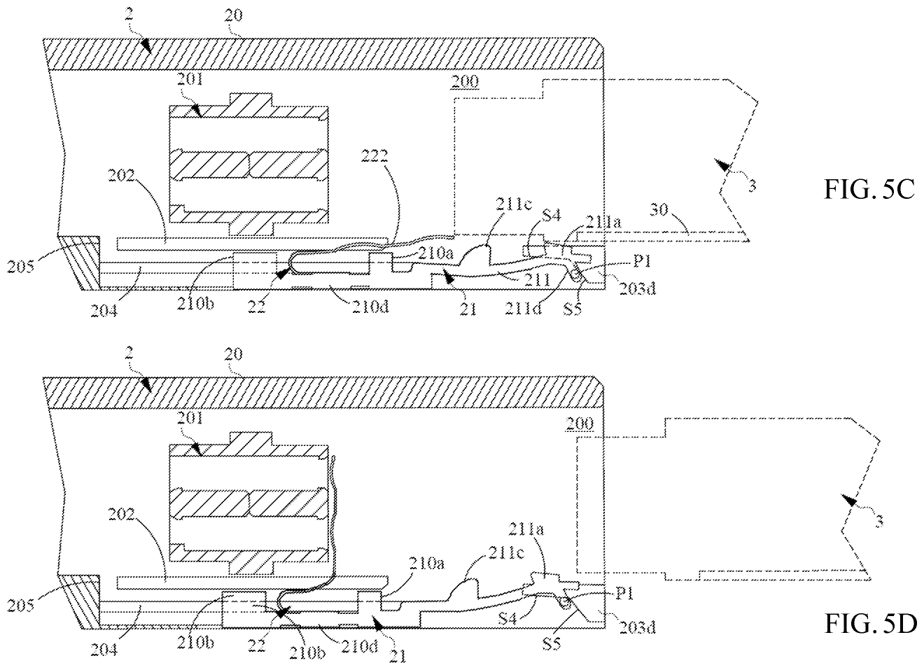

Next, the operation method of the driving structure in this embodiment would be described. As shown in FIG. 5A, which is a schematic diagram of an embodiment of inserting an optical connector into a receptacle. When the optical connector 3 is inserted into the receptacle 2, the end surface 31 of the optical connector 3 is leaned against the first leaning surface S1 of the first actuating structure 211a of the driving structure 21 and moves toward the receptacle 2. When the optical connector 2 is inserted, the driving structure 21 also moves simultaneously with the optical connector 2, thereby driving the covering piece 222 of the flexible covering structure 22 to rotate clockwise, so that the optical connector 2 and the coupling part 201 are coupled together. The way in which the driving structure 21 drives the flexible covering structure 22 to move during the process is as shown in the aforementioned FIGS. 3B to 3D and would not be repeated herein. Next, the operation way of the optical connector 2 would be explained when it is pulled-out.

Please refer to FIGS. 5B to 5D, which are schematic diagrams of an embodiment of the flexible covering structure covering the coupling part when the optical connector of the present invention is pulled out from the receptacle. As shown in FIG. 5B, the user would like to pull out the optical connector 3 from the receptacle 2. During the pull-out process, the inner wall 300 of the groove 30 of the optical connector 3 is leaned against the first actuating structure 211a of the second leaning surface S2. Therefore, when the optical connector 3 is pulled out, the inner wall 300 of the groove 30 pushes the driving structure 21 outwardly, thereby driving the driving structure 21 to move outwardly. As shown in FIG. 5C, when the optical connector 3 continues to be pulled outwardly, the fourth limiting structure 211d on the driving structure 21 is leaned against the second limiting structure 203d. In this embodiment, the stopping column P1 of the fourth limiting structure 211d is leaned against the guiding slope 203e of the second limit structure 203d, and is pressed by the guiding slope 203e to further drive the cantilever 211 to bend in the clockwise direction, so that the first actuating structure 211a is separated from the groove 30. In one embodiment, the stopping column P1 is initially pressed by the first guiding slope S4 of the guiding slope 203e. Since the first guiding slope S4 has a slope, the cantilever 211 is flexibly bent in the clockwise direction due to the pressure from the slope, so that the first actuating structure 211a gradually separated from the groove 30.

As shown in FIG. 5D, after the cantilever 211 flexes clockwise to cause the first actuating structure 211a to be separated from the groove, the elastic force accumulated in the cantilever 211 is released to lift the first actuating structure 211a upwardly. Since the first actuating structure 211a is no longer restrained by the groove 30, while the optical connector 3 continues to be pulled out and separated from the receptacle 2, the first actuating structure 211a gradually rises due to the elastic restoring force of the cantilever. After the optical connector 3 is finally separated from the receptacle 2, the first actuating structure 211a also returns to the initial position.

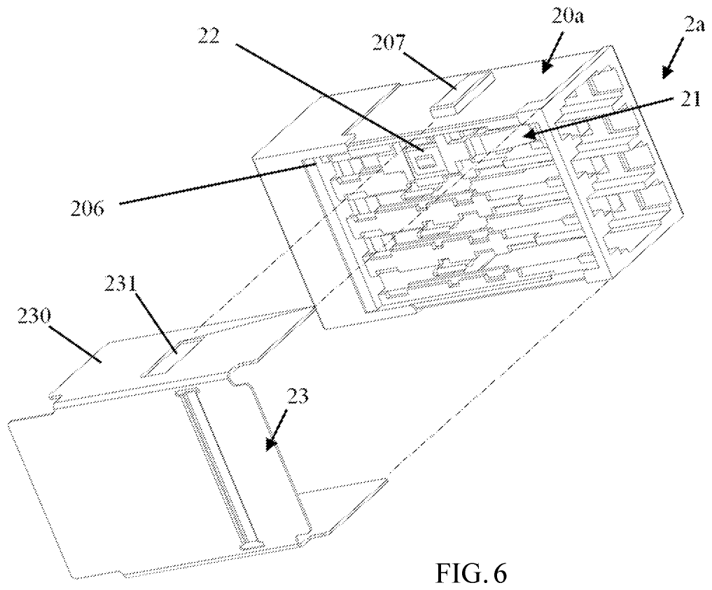

Please refer to FIG. 6, which is a schematic diagram of another embodiment of the receptacle body in the present invention. In this embodiment, the receptacle body 20a of the receptacle 2a has a bottom opening 206, which is opened on the bottom surface of the receptacle body 20a to install driving structure 21 and the flexible covering structure 22. The receptacle 2a has a covering plate 23 and the bottom opening 206 covered by the receptacle 2a. In this embodiment, side plates 230 extend on both sides of the covering plate 23 and are combined with the side surfaces of the receptacle body 20a. A first buckle structure 207 is disposed on the side of the receptacle body 20a and connected with a second buckle structure 231 of the side plate 230. This allows the covering plate 23 to be firmly combined with the receptacle body 20a to protect the driving structure 21 and facilitate disassembly and maintenance.

In summary, the receptacle for the optical connector in the present invention has a protective design that protects the coupling part of the optical connector from contamination and drives the flexible covering structure out of the covering position when the optical connector is inserted, so that the optical connector is smoothly coupled to the receptacle, and when the optical connector is pulled out, the flexible covering structure is driven back to its original position to protect the receptacle from dust contamination.

It will be understood that the above description of embodiments is given by way of example only and that various modifications may be made by those with ordinary skill in the art. The above specification, examples, and data provide a complete description of the present invention and use of exemplary embodiments of the invention. Although various embodiments of the invention have been described above with a certain degree of particularity, or with reference to one or more individual embodiments, those with ordinary skill in the art could make numerous alterations or modifications to the disclosed embodiments without departing from the spirit or scope of this invention.

What is claimed is:

1. A receptacle inserted by an optical connector, comprising:
a receptacle body, having a slot, the slot having a coupling part, the coupling part having a coupling through hole, which is coupled with the optical connector inserted through the slot;
a driving structure, slidably disposed into the slot, wherein when the optical connector is inserted into the slot, the driving structure is pushed by the optical connector to move to a first position, and when the optical connector is moved by a pulling force, the driving structure is pushed by the optical connector to move to a second position; and
a flexible covering structure, connected to the driving structure, wherein when the driving structure is in the first position, the flexible covering structure bends to reveal the coupling through hole, and when the driving structure moves to the second position, the flexible covering structure blocks the coupling through hole.

2. The receptacle of claim 1, wherein the receptacle body has a first limiting structure and a second limiting structure, the first limiting structure is disposed on an inner wall of the slot and is located on a side of the coupling part, and the second limiting structure is disposed on the inner wall adjacent to an insertion opening of the slot.

3. The receptacle of claim 2, wherein the driving structure has a sliding base and a cantilever, the sliding base is slidably located at a bottom of the slot, one end of the cantilever is connected to a side of the sliding base, and the other end of the cantilever extends toward the insertion opening of the slot.

4. The receptacle of claim 3, wherein the cantilever has a first actuating structure, a second actuating structure and a third limiting structure, the first actuating structure is disposed at a free end of the cantilever, the second actuating structure is disposed on the cantilever closed to the sliding base, and the third limiting structure is disposed on both sides of the first actuating structure.

5. The receptacle of claim 4, wherein the first actuating structure has a first leaning surface, a second leaning surface, and an inclined surface respectively connected to the first leaning surface and the second leaning surface; when the optical connector is inserted into the slot, the optical connector is leaned against the first leaning surface and pushes the driving structure to move to the first position, causing the second actuating structure to contact the first limiting position, and the cantilever is driven to bend downward by a force of the first limiting structure during a moving process of the optical connector; when the driving structure moves to the first position, the first leaning surface is separated from the optical connector.

6. The receptacle of claim 5, wherein after the first leaning surface is separated from the optical connector, the optical connector moves toward the coupling part, causing the optical connector to press the cantilever; when the optical connector is coupled with the coupling part, the first actuating structure is embedded into a groove at a bottom of the optical connector, and a height of the third limiting structure is lower than a height of the second limiting structure.

7. The receptacle of claim 5, wherein when the optical connector is pulled by the pulling force, a side wall of a groove at a bottom of the optical connector is leaned against the second leaning surface of the first actuating structure; as the optical connector moves, the driving structure is driven to move to the second position, so that the flexible covering structure returns to cover the coupling part, and the third limiting structure moves along a bottom surface of the second limiting structure as the driving structure moves; when the driving structure moves to the second position, the first actuating structure is separated from the groove, and the third limiting structure is separated from the second limiting structure, so that the cantilever returns to an unbending structure.

8. The receptacle of claim 3, wherein the sliding base has a plurality of first guiding structures, an inner wall of a bottom of the receptacle body has a second guiding structure corresponding to the first guiding structure, and the second guiding structure slidably contacts with the first guiding structure.

9. The receptacle of claim 1, wherein the receptacle body has a first limiting structure and a second limiting structure, the first limiting structure is disposed on an inner wall of the slot and is located on a side of the coupling part, the second limiting structure is disposed on an insertion opening of the slot and extends toward the coupling part, and a bottom surface of the second limiting structure has a guiding slope.

10. The receptacle of claim 9, wherein the cantilever has a first actuating structure, a second actuating structure and a fourth limiting structure, wherein the first actuating structure is disposed at a free end of the cantilever, and the second actuating structure is disposed on the cantilever closed to the sliding base, and the fourth limiting structure is disposed on a bottom of the first actuating structure.

11. The receptacle of claim 10, wherein the first actuating structure has a first leaning surface, a second leaning surface, and an inclined surface respectively connected to the first leaning surface and the second leaning surface; when the optical connector is inserted into the slot, the optical connector is leaned against the first leaning surface and pushes the driving structure to move to the first position, causing the second actuating structure to contact the first limiting position, and the cantilever is driven to bend downward by a force of the first limiting structure during a moving process of the optical connector; when the driving structure moves to the first position, the first leaning surface is separated from the optical connector.

12. The receptacle of claim 11, wherein when the optical connector is pulled by the pulling force, a side wall of a groove of the optical connector is leaned against the second leaning surface of the first actuating structure; as the optical connector moves, the driving structure is driven to move toward the second position; when the driving structure moves to the second position, the flexible covering structure returns to cover the coupling part, the fourth limiting structure is leaned against the guiding slope, the first actuating structure is separated from the groove, and the fourth limiting structure accumulates an elastic force by bending the cantilever to move along the guiding slope, so that the cantilever returns to an unbending structure.
